(19) United States
(12) Patent Application Publication
(10) Pub. No.: US 2012/0024952 A1
(43) Pub. Date: Feb. 2, 2012

(54) SYSTEM AND METHOD FOR IDENTIFYING QR CODE

(75) Inventor: Yu-Hsiang Chen, Tu Cheng (TW)

(73) Assignee: Cheng Uei Precision Industry Co., LTD., Tu Cheng City (TW)

(21) Appl. No.: 12/849,005

(22) Filed: Aug. 2, 2010

(51) Int. Cl. G06K 7/14

(52) U.S. Cl. 235/454

(57) ABSTRACT

Disclosed is a system and method for identifying a QR (Quick Response) code. The method includes steps of simultaneously obtaining a first image and a second image respectively representing the QR code, geometrically transforming the second image into a third image, subtracting each pixel value and the average pixel value of the first image and the third image to respectively form a fourth image and a fifth image, comparing each of corresponding pixels of the fourth image and the fifth image to form a sixth image, and setting each pixel of the sixth image into 1 if each pixel is over a threshold and setting each pixel into 0 if each pixel is below the threshold.

### TECHNICAL FIELD OF THE INVENTION

The present invention relates to a two-dimension barcode, and especially to a system and method for identifying a QR (Quick Response) code formed on a metal surface.

### BACKGROUND OF THE INVENTION

A two-dimension barcode is a new technology of information storage and transmission, being widely used in various applications, including product identification, security and anti-counterfeiting, and E-commerce. The two-dimension barcode records data information with specific geometric patterns of black and white graphic symbols arranged in two-dimension directions. The concept of logical basis of “0” and “1” bit stream adopted in computer systems is utilized to form graphic symbols that correspond to binary representation of text and numerical information. The graphic symbols can be read by an image input device or a photoelectric scanning device to achieve automatic information processing.

The International standards of the two-dimension barcode include, for example, PDF417, Data Matrix, Maxi Code, and QR (Quick Response) Code, among which QR code is most widely used. The QR code shows an advantage of high-speed and all-direction (360 degrees) accessibility, and is capable of representation of Chinese characters, rendering QR code wide applicability in various fields. The QR code comprises a square array of a series of small square message blocks, in which “0” or “1” are represented through variation of gray levels of bright and dark blocks. For applications such as automobile manufacturing, aircraft manufacturing, weapon manufacturing, and various mechanical products, the QR code must be formed via engraving on a metal surface or a plastic surface. However, the QR code formed thereof through engraving leads to a contrast between bright and dark blocks that has poorer quality than a contrast obtained in a printed surface. This makes the identification of QR code on a metal surface difficult, eventually resulting in distortion of identified data.

Therefore, it is desired to have a system and method for identifying a QR code to overcome the aforesaid drawbacks.

### SUMMARY OF THE INVENTION

An objective of the present invention is to provide a highly stable and identifiable system for identifying a QR (Quick Response) code.

Another objective of the present invention is to provide a highly stable and efficient method for identifying a QR code.

To achieve the foregoing objectives, according to an aspect of the present invention, a system for identifying a QR code is provided, comprising a camera module and a processor electrically coupled to the camera module. The camera module has a first camera, a second camera, a controller, a uniform light source, a memory, and a power regulator. The first camera comprises a first lens and a first sensor coupled to the first lens, and the second camera comprises a second lens and a second sensor coupled to the second lens. The controller is simultaneously coupled to the first sensor and the second sensor, and the controller is coupled to the processor. The uniform light source and a memory are respectively electrically coupled to the controller. The power regulator is respectively electrically coupled to the first sensor, the second sensor, the controller and the processor. Accordingly, the first lens faces toward a predetermined first datum surface, and an optical axis of a centre of the first lens intersects a predetermined second datum surface at a focal point of the first lens. The first lens is located between the second lens and the uniform light source, and the first lens, the second lens and the uniform light source are located at the same plane. A centre of the second lens is located at a reflected ray which is emitted from an optical axis of the uniform light source through the focal point on the predetermined second datum surface.

According to another aspect, the present invention further provides a method for identifying the QR code, the method comprises the steps of: utilizing a first camera and a second camera to simultaneously obtain a first image and a second image representing the QR code; forming a third image via geometrically transforming the second image into a normal square shape of the QR code; subtracting each pixel value of message unit blocks of the first image and the third image from the average pixel value of the first image and the third image and then calculating an absolute value to respectively form a fourth image and a fifth image; comparing each of corresponding pixels of the fourth image and the fifth image to form a sixth image; and setting a threshold to binarize the sixth image.

As mentioned above, the system and method for identifying the QR code according to the present invention employ the design of the two cameras according to the concept of a differential signal formed thereof. The QR code can be efficiently and stably identified by tilting the two cameras and light emission. The objective of the highly stable and efficient method for identifying the QR code is achieved by the steps of transforming the image, subtracting the corresponding pixel values, calculating the absolute value, setting the threshold to determine the area is 0 or 1, and then identifying the QR code.

### BRIEF DESCRIPTION OF THE DRAWINGS

FIG. 1 is a schematic top view illustrating a QR code according to the present invention.

FIG. 2 is a schematic perspective view of the structure of a white message unit blocks representing a bright plane of the QR code of FIG. 1.

FIG. 3 is a schematic perspective view of the structure of a black message unit blocks representing a scattering plane of the QR code of FIG. 1.

FIG. 4 is a flow chart illustrating a manufacturing method of the QR code according to the present invention.

FIG. 5 is a block diagram illustrating a system for identifying a QR code according to the present invention.

FIG. 6 is a schematic diagram illustrating a concept for identifying a QR code according to the present invention.

FIG. 7 is a schematic diagram illustrating the first camera and the second camera are simultaneously connected to the controller shown in FIG. 5.

FIG. 8 is a flow chart illustrating a method for identifying a QR code according to the present invention.

### DETAILED DESCRIPTION OF THE INVENTION

Reference will now be made in detail to the present preferred embodiments of the invention, examples of which are illustrated in the accompanying drawings.

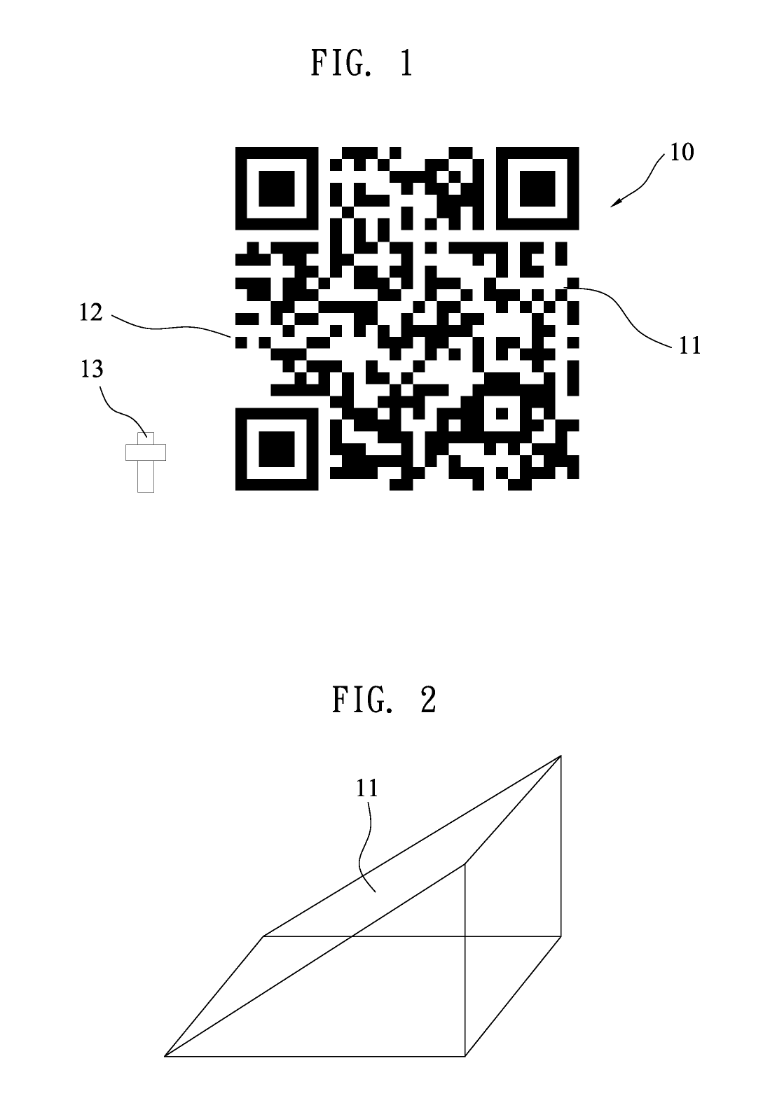

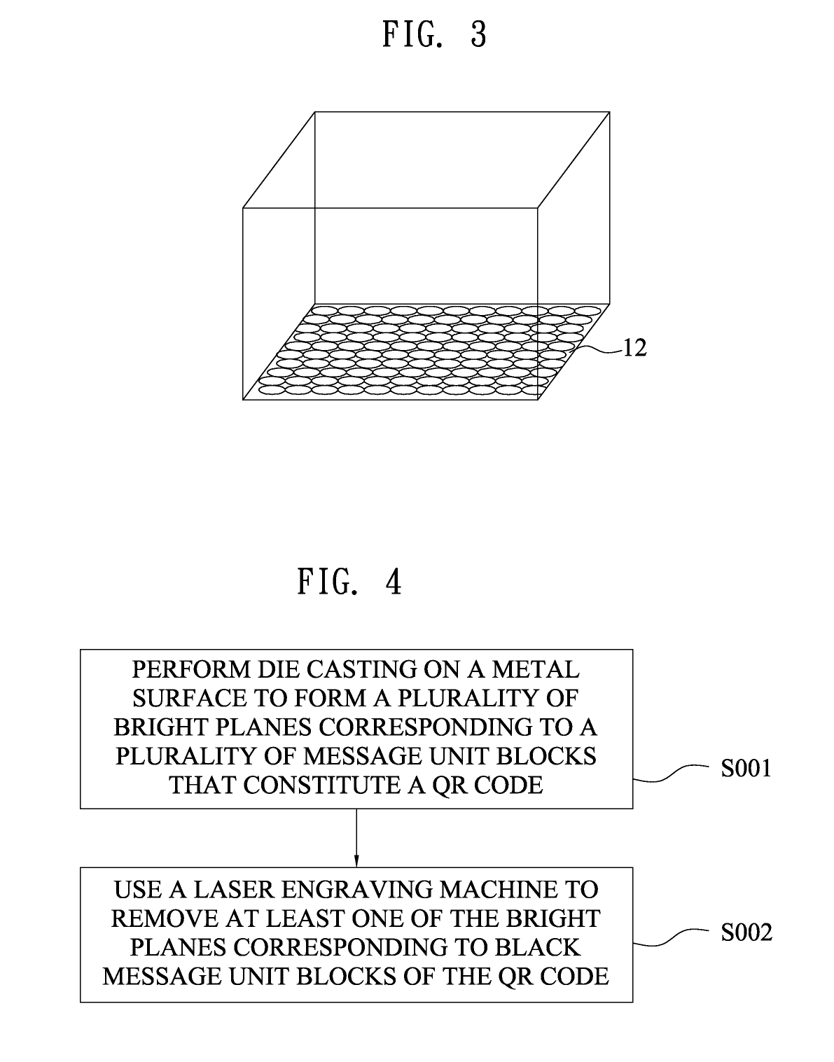

With reference to the drawings and in particular to FIGS. 1-3, a QR code according to the present invention, generally designated as 10, is applicable to formation on a metal surface or a plastic surface. The QR code 10 is a square block composed of a plurality of message unit blocks, which are square, arranged without gaps according to certain rules. The message unit blocks include white and black blocks respectively representing different binary values. In accordance with one preferred embodiment of the present invention, the white message unit blocks of the QR code 10 are represented as bright planes 11 formed on a metal surface through die casting. The bright planes 11 of the white message unit blocks are set at an inclination angle φ with respect to a horizontal plane. Preferably, the angle φ is between 0 and 45 degrees.

The black message unit blocks of the QR code 10 are represented as scattering planes 12 in accordance with one preferred embodiment of the present invention. The scattering planes 12 are formed on the same plane, which is parallel to the horizontal plane. With the white and black message unit blocks of the QR code 10 represented as bright planes 11 and scattering planes 12, the contrast therebetween is enhanced, as well as readability and stability are improved.

Reference is now made to FIG. 4 for illustrating a manufacturing method of the QR code 10. The method of FIG. 4 begins at step S001.

At step S001, die casting is performed to form bright planes on a metal surface respectively corresponding to message unit blocks that constitute the QR code, which the bright planes of the message unit blocks are set at an identical inclination angle with respect to a horizontal plane.

At step S002, a laser engraving machine is used to remove one or more of the bright planes corresponding to positions of black message unit blocks of the QR code to form scattering planes that are set on the same plane parallel to the horizontal plane.

Specifically, the manufacturing method further comprises a step of forming a positioning block 13 through die casting in front of the step S001, wherein the QR code 10 is formed on one side of the positioning block 13 with edges of the QR code 10 respectively perpendicular to edges of the positioning block 13. As indicated by the positioning block 13, bright planes 11 can be easily formed on a metal surface with identical inclination through die casting, the laser engraving machine may easily acquire position information of the QR code 10 to accurately and quickly remove the bright planes 11 corresponding to the black message unit blocks of the QR code 10 for forming desired scattering planes 12.

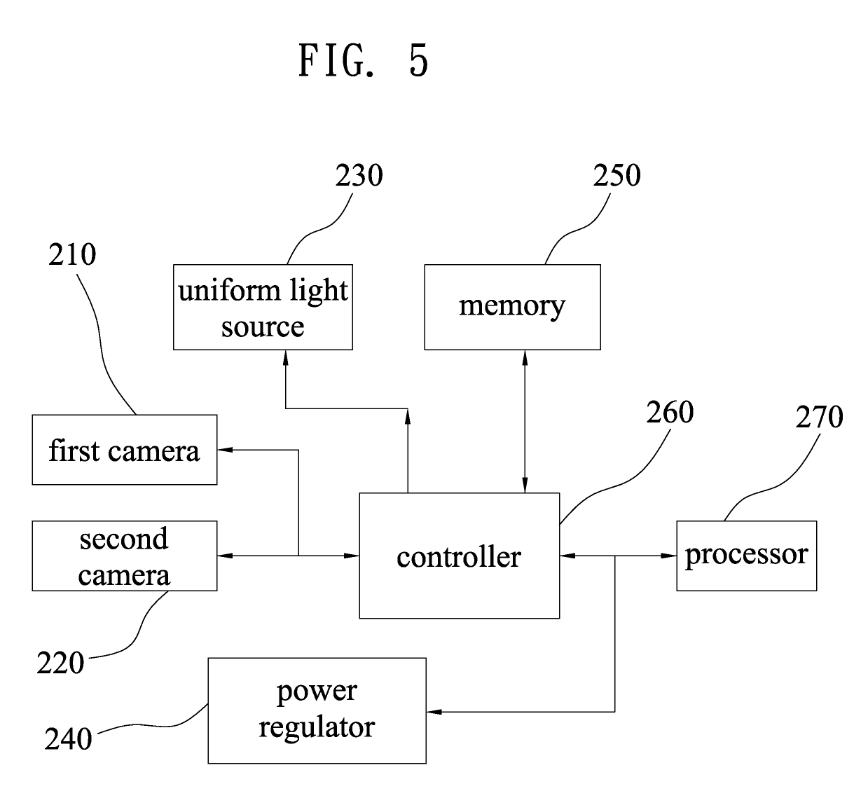

Referring to FIG. 5, the system for identifying a QR code according to the present invent comprises a camera module and a processor 270 electrically coupled to the camera module. The camera module has a first camera 210, a second camera 220, a uniform light source (LS) 230, a power regulator 240, a memory 250 and a controller 260. The first camera 210 and the second camera 220 are simultaneously coupled to the controller 260. The uniform light source 230 and the memory 250 are respectively electrically coupled to the controller 260. The power regulator 240 is respectively electrically coupled to the first camera 210, the second camera 220, the controller 260 and the processor 270. The controller 260 is coupled to the processor 270. The memory 250 herein is utilized to store image data. The processor 270 herein is a computer terminal for supplying power to the first camera 210, the second camera 220 and the controller 260 via the power regulator 240.

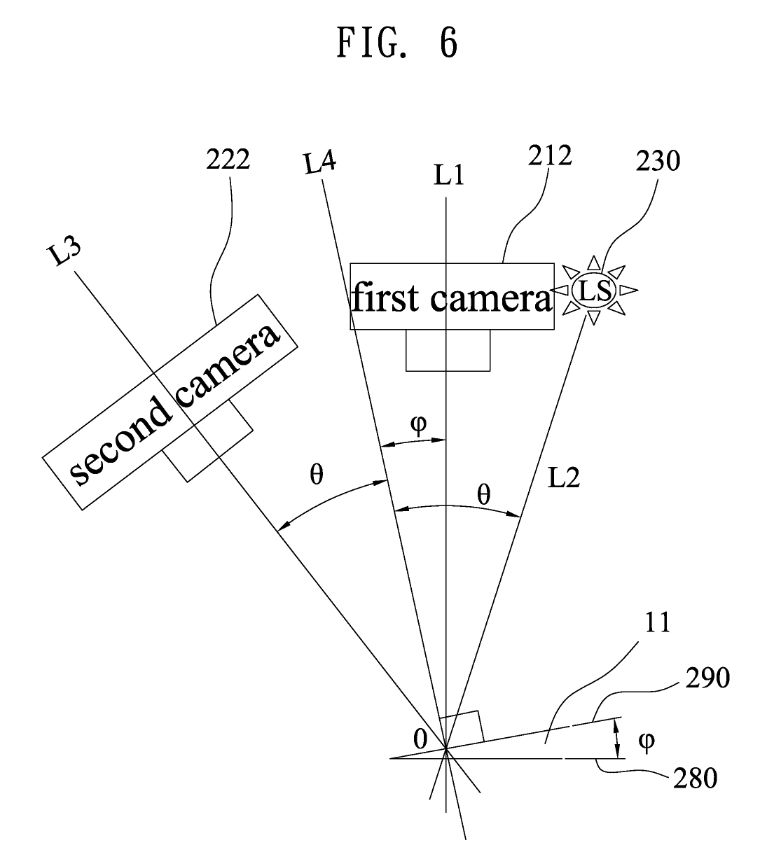

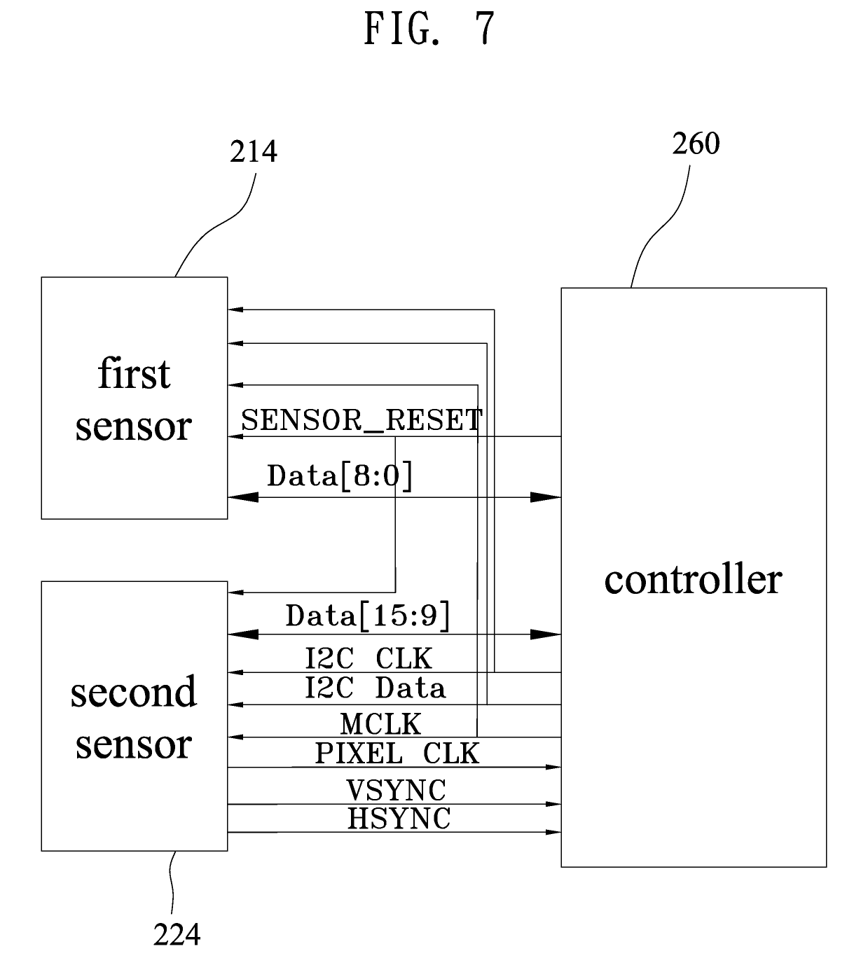

Referring to FIG. 6 and FIG. 7, specifically, the first camera 210 comprises a first lens 212 and a first sensor 214, and the second camera 220 comprises a second lens 222 and a second sensor 224. The first lens 212 and second lens 222 are used to collect images; in addition, the first sensor 214 and the second sensor 224 are simultaneously coupled to the controller 260. A predetermined first datum surface 280 and a predetermined second datum surface 290 are located as shown in FIG. 6. The predetermined first datum surface 280 is parallel to a horizontal plane, and the angle between the predetermined first datum surface 280 and the predetermined second datum surface 290 is equal to the tilt angle φ. The first lens 212 is facing toward the predetermined first datum surface 280, and an optical axis L1 of a centre of the first lens 212 intersects a predetermined second datum surface 290 at a focal point 0 of the first lens 212. In addition, the first lens 212 is located between the second lens 222 and the uniform light source 230; in addition, the first lens 212, the second lens 222, and the uniform light source 230 are located at the same plane. Moreover, a centre of the second lens 222 is located at a reflected ray L3 which is emitted from an optical axis L2 of the uniform light source 230 through the focal point 0 on the predetermined second datum surface 290.

The system for identifying the QR code 10 of the present invention employs the design of tilting the two cameras and light emission. Specifically, the first lens 212 faces toward the QR code 10 is for collecting images, that is, the bright planes 11 is corresponding to the predetermined first datum surface 280, and the scattering planes 12 is corresponding to the predetermined second datum surface 290. The first lens 212 is perpendicular to the scattering planes 12 and intersects the bright planes 11 at the focal point 0. In addition, the angle between the first lens 212 and a normal line L4 at 0 of the bright planes 11 is φ. The two angles between the optical axis L2 of the uniform light source 230 and the normal line L4 and between the centre of the second lens 222 and the normal line L4 are θ, which is larger than φ. If the bright planes 11 are smooth metal surfaces to collect images, the second lens 222 receives a brighter value of pixel via a strengthened image from the uniform light source 230. The subtraction between collected brightness values from the two cameras is greater than 0. Besides, on a black block (i.e., the scattering planes 12 represent the black message unit block), the bright planes 11 are formed as a non-smooth scattering surfaces 12 by a laser engraving machine, so the collected brightness values from the first lens 212 and the second lens 222 are similar, and thereby the subtraction between collected brightness values from the two cameras is closed to 0. Accordingly, the decoding can be implemented by setting a threshold to distinguish “0” and “1”.

Specifically, referring to FIG. 7, a CMOS image sensor chip or a CCD sensor chip can be used as the sensor. Take an OV series camera chip for example, when the chip is simultaneously coupled to the controller 260, the data pins of the first sensor 214 and the second sensor 224 respectively connected to the I/O pins of the controller 260 for transmitting the image signals obtained by the sensors to the controller 260. The corresponding SENSOR_RESET pins, 12C CLK pins, 12C Data pins, MCLK pins of the first sensor 214 and the second sensor 224 are simultaneously coupled to the controller 260. In addition, the HSYNC pin, VSYNC pin and PIXEL CLK pin are individually connected to the controller 260. More specifically, the SENSOR_RESET Pins are utilized to make the first sensor 214 and the second sensor 224 simultaneously into the initialization state. The common 12C CLK pin and 12C Data pin for the two sensors are utilized to process command settings of the initialization state. One group of functional signal pins: HSYNC/VSYNC/PIXEL CLK pin are utilized to implement synchronization signals, thereby receiving the image data of both the two sensors.

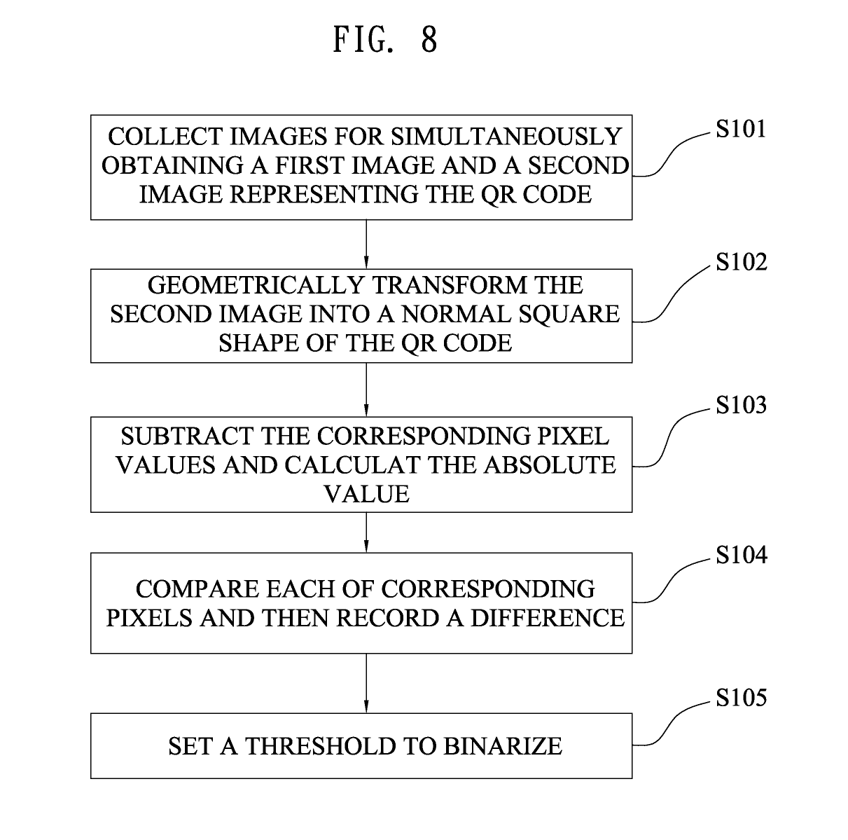

Referring to FIG. 8, the method for identifying the QR code begins at step S101.

At step S101, the system for identifying QR code is utilized to collect images, that is, a first camera and a second camera are utilized to simultaneously obtain a first image and a second image representing the QR code.

At step S102, a third image is formed via geometrically transforming the second image into a normal square shape of the QR code.

At step S103, each pixel value of message unit blocks of the first image and the third image is subtracted from the average pixel value of the first image and the third image, and then an absolute value is calculated to respectively form a fourth image and a fifth image.

At step S104, each of corresponding pixels of the fourth image and the fifth image is compared, and then a difference is recorded to form a sixth image.

At step S105, a threshold is set to binarize the sixth image.

Due to different collecting angles of the first lens 212 and second lens 222, the obtained images with geometric distortion, which the bar code image is not a square shape but a quadrilateral shape, are caused by the camera angle of the second lens 222. Therefore, step S102 is needed to geometrically transform the obtained images to correct the geometric distortion. The QR code is identified in the sixth image by deciding closed to 0 or from 0. According to the characteristics of the camera for selecting the appropriate threshold to distinguish “0” and “1” thereby decoding as binary digits, the objective of a highly efficient and stable method for identifying the QR code is achieved by aforesaid steps.

As mentioned above, the system and method for identifying the QR code according to the present invention employ the design of the two cameras according to the concept of a differential signal. The QR code can be identified efficiently and stably by tilting the two cameras and light emission. The objective of the highly stable and efficient method for identifying the QR code is achieved by the steps of transforming the image, subtracting the corresponding pixel values, calculating the absolute value, setting the threshold to determine the area is 0 or 1, and then identifying the QR code.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A system for identifying a QR (Quick Response) code, comprising:
a camera module and a processor electrically coupled to the camera module, the camera module having:
a first camera comprising a first lens and a first sensor coupled to the first lens;
a second camera comprising a second lens and a second sensor coupled to the second lens;
a controller simultaneously coupled to the first sensor and the second sensor, the controller being coupled to the processor;
a uniform light source and a memory respectively electrically coupled to the controller; and
a power regulator respectively electrically coupled to the first sensor, the second sensor, the controller and the processor;
wherein the first lens faces toward a predetermined first datum surface, and an optical axis of a centre of the first lens intersects a predetermined second datum surface at a focal point of the first lens, and wherein the first lens is located between the second lens and the uniform light source, which the first lens, the second lens and the uniform light source are located at the same plane, and wherein a centre of the second lens is located at a reflected ray which is emitted from an optical axis of the uniform light source through the focal point on the predetermined second datum surface.

2. The system of claim 1, wherein the QR code, which is square, comprises a plurality of message unit blocks, which are square, arranged without gaps according to certain rules, and the message unit blocks comprise a plurality of white and black message unit blocks respectively indicating different binary values.

3. The system of claim 2, wherein the white message unit blocks of the QR code have a plurality of bright planes formed by die-casting a metal surface, and each the bright plane of the white message unit blocks being disposed at an tilt angle to a horizontal plane; and the black message unit blocks of the QR code have a plurality of scattering planes formed on the metal surface, and the scattering planes are parallel to the horizontal plane.

4. The system of claim 3, wherein the predetermined first datum surface is parallel to the horizontal plane, and an angle between the predetermined first datum surface and the predetermined second datum surface is equal to the tilt angle.

5. A method for identifying a QR code, the method comprising the steps of:
utilizing a first camera and a second camera to simultaneously obtain a first image and a second image representing the QR code;
forming a third image via geometrically transforming the second image into a normal square shape of the QR code;
subtracting each pixel value of message unit blocks of the first image and the third image from the average pixel value of the first image and the third image and then calculating an absolute value to respectively form a fourth image and a fifth image;
comparing each of corresponding pixels of the fourth image and the fifth image, and then recording a difference to form a sixth image; and
setting a threshold to binarize the sixth image.
